(19) United States
(12) Patent Application Publication
(10) Pub. No.: US 2008/0218402 A1
(43) Pub. Date: Sep. 11, 2008

(54) Target detector and target detection method

(75) Inventor: Yuuji Matsuura, Fukuoka (JP)

Correspondence Address: HANIFY & KING PROFESSIONAL CORPORATION, 1875 K STREET, NW, SUITE 707, WASHINGTON, DC, 20006, US

(73) Assignee: Fujitsu Limited

(21) Appl. No.: 11/976,116

(22) Filed: Oct. 22, 2007

(30) Foreign Application Priority Data
Oct. 31, 2006 (JP) 2006-296052

(51) Int. Cl. G01S 13/58

(52) U.S. Cl. 342/109

(57) ABSTRACT

A target detector for accurately detecting frequency components of the stationary target, detecting a moving target from the remaining frequency components and suppressing erroneous detection of the moving target. The detector comprises: a transmitting and receiving section for transmitting a transmission wave and receiving a reflected wave from the target, the transmission wave having a frequency rising section where the frequency increases and a frequency falling section where the frequency decreases; a mixer for mixing the transmission wave and the reflected wave to generate beat signals; a frequency calculating section for calculating frequency components of the beat signals in the frequency rising section and the frequency falling section; and a stationary target frequency detecting section for, when a level of the frequency components in one of the frequency rising section and the frequency falling section exceeds a higher threshold and a level of the same frequency components in the other section exceeds a lower threshold as well as a level difference between both the frequency components is within a predetermined range, detecting these frequency components as those of the stationary target.

### CROSS-REFERENCE TO RELATED APPLICATIONS

This application is based upon and claims the benefits of priority from the prior Japanese Patent Application No. 2006-296052, filed on Oct. 31, 2006, the entire contents of which are incorporated herein by reference.

### BACKGROUND OF THE INVENTION

1. Field of the Invention

The present invention relates to a target detector and a method of detecting a target. More particularly, the present invention relates to a target detector for calculating a relative distance and relative velocity to a target. The invention also pertains to a method of detecting the target using the target detector.

2. Description of the Related Art

There is a target detector using Frequency Modulated Continuous Wave (FM-CW) to detect a relative distance and relative velocity to a moving target such as vehicles. The target detector transmits a radio wave such as a millimeter wave while sweeping its frequency and detects a frequency difference between a frequency of a reflected wave from a target and a frequency of a currently transmitting radio wave to thereby calculate a relative distance and relative velocity to the moving target.

When a target moves, a frequency of the reflected wave changes due to the Doppler effect. Therefore, it is necessary to distinguish an influence due to a frequency difference depending on a distance (caused by a round-trip time difference) and an influence due to a frequency difference depending on a velocity (caused by the Doppler effect). Accordingly, a frequency difference between a frequency rising section and a frequency falling section is detected within the near time period, and a frequency difference caused by independent influence of each factor is determined by a predetermined calculation. A frequency shift due to a moving target is qualitatively analyzed as in the following (a) to (d). Although a specific equation is omitted, when the frequency shift is measured under two conditions of the frequency rising section and the frequency falling section, a frequency difference caused by the independent influence of each of a distance and a velocity can be determined by solving simultaneous equations.

(a) A frequency of the received reflected wave is a frequency transmitted a round-trip time ago. Therefore, the frequency becomes lower than a current transmission frequency depending on a distance in the frequency rising section.

(b) A frequency of the received reflected wave is a frequency transmitted a round-trip time ago. Therefore, the frequency becomes higher than the current transmission frequency depending on a distance in the frequency falling section.

(c) A frequency of the reflected wave from an approaching target becomes higher depending on the velocity due to the Doppler effect. Accordingly, the frequency difference decreases in the above-described (a) section, and increases in the above-described (b) section. Assume here that a frequency difference caused by a round-trip time difference is larger than that caused by the Doppler effect.

(d) A frequency of the reflected wave from a retreating target becomes lower depending on the velocity due to the Doppler effect. Accordingly, the frequency difference increases in the above-described (a) section, and decreases in the above-described (b) section. Assume here that a frequency difference caused by a round-trip time difference is larger than that caused by the Doppler effect.

FIG. 7 shows an example of changes in frequencies of a transmission wave output from the target detector. The target detector outputs, for example, a transmission wave whose frequency is changed in the form of the triangular wave as shown in FIG. 7. A frequency of the transmission wave is divided into a frequency rising section 101 and a frequency falling section 102 as shown in FIG. 7. In FIG. 7, the horizontal axis represents the time and the vertical axis represents the frequency.

FIGS. 8A, 8B and 8C show a frequency spectrum of a beat signal between the transmission wave and the reflected wave. FIG. 8A shows a frequency spectrum of a beat signal (beat: frequency difference components of two signals which is included in a mixture of the two signals) between the transmission wave and the reflected wave when a target remains stationary (a target is not moving or moving extremely slow). FIG. 8B shows a frequency spectrum of a beat signal when a target is approaching the detector. FIG. 8C shows a frequency spectrum of a beat signal when a target is receding from the detector. In FIG. 8, the horizontal axis represents the frequency and the vertical axis represents the power level of the reflected wave.

When a target remains stationary, a frequency spectrum 111 of the beat signal in the frequency rising section (UP) and a frequency spectrum 112 of the beat signal in the frequency falling section (DOWN) overlap as shown in FIG. 8A. For the distinction, the frequency spectrums 111 and 112 are represented at a distance in FIG. 8A.

When a target approaches the detector, the frequency spectrum 113 of the beat signal in the frequency rising section and the frequency spectrum 114 of the beat signal in the frequency falling section appear symmetrically across a peak position (frequency f1) at the time when the velocity to the target (hereinafter, the velocity means a relative velocity between the target detector and the target) is zero, as shown in FIG. 8B.

When a target recedes from the detector, the frequency spectrum 115 of the beat signal in the frequency falling section and the frequency spectrum 116 of the beat signal in the frequency rising section appear symmetrically across a peak position (frequency f1) at the time when the relative velocity to the target is zero, as shown in FIG. 8C. Note, however, that the positions of the UP and DOWN frequencies that appear symmetrically are switched with those in FIG. 8B.

The target detector can calculate a distance to a target (hereinafter, the distance means a relative distance between the target detector and the target) based on the frequency f1. Further, the detector can calculate whether the target is approaching or receding from the detector, based on the positions of the frequencies of beat signals in the frequency rising section and the frequency falling section, which appear symmetrically across the frequency f1. Further, the detector can calculate a velocity to a target based on the frequency difference between the beat signals in the frequency rising section and the frequency falling section.

In general, the target detector mixes an output wave (transmission wave) from an internal oscillator and a reflected wave returned to the oscillator, and extracts a low frequency side (frequency difference components (the above-described beat signals)) from the mixture. Further, the detector subjects the extracted beat signal to analog-digital conversion and analyzes the spectrum of the resulting signal by the digital signal processing. Specifically, the detector lists the peak frequency component higher than a predetermined threshold in the frequencies (which are referred to as distance frequencies hereinafter, and actually include velocity information) of the beat signals in the frequency rising section and the frequency falling section. Thereafter, the detector performs pairing of these frequency components using a variety of algorithms and calculates a relative distance and relative velocity to each target (the stationary target and the moving target).

Here, the frequency spectrum of the distance frequencies of the stationary target has the same frequency in the frequency rising section and the frequency falling section as described in FIG. 8A. However, the frequency spectrum of the distance frequencies of the moving target has a different frequency in the frequency rising section and the frequency falling section as described in FIGS. 8B and 8C. Accordingly, the target detector first classifies as the distance frequencies corresponding to the stationary target a pair of distance frequencies whose frequencies are the same in both the sections and whose level difference is within the predetermined range. Thereafter, the target detector classifies the distance frequencies remaining after removing the pair of the distance frequencies as those corresponding to the moving target, which have a different frequency in the frequency rising section and the frequency falling section.

FIG. 9 illustrates the listing of the distance frequencies. The number of targets for measuring the relative distance and the relative velocity is not limited to one. Further, varied noise components are included in the reflected wave returned to the target detector. Accordingly, the distance frequencies calculated by the target detector include varied frequencies as shown in FIG. 9. From the distance frequencies shown in FIG. 9, the target detector extracts only the distance frequencies having a level exceeding a predetermined threshold. The target detector performs the listing of the distance frequencies in each section of the respective frequency rising section and the frequency falling section.

FIGS. 10A and 10B illustrate the pairing. FIG. 10A shows a frequency spectrum of the distance frequencies in the frequency rising section, which are listed while being limited only to the peak frequency component higher than a predetermined threshold.

FIG. 10B shows a frequency spectrum of the distance frequencies in the frequency falling section, which are listed while being limited only to the peak frequency component higher than a predetermined threshold.

As described above, when a target remains stationary, the distance frequencies in both the sections are coincident with each other. Accordingly, the target detector first recognizes as the distance frequencies of the stationary target a pair of distance frequencies which are coincident with each other in both the sections and whose level difference is within a predetermined range. For example, the distance frequencies indicated by the broken lines are coincident with each other in both sections as shown in FIGS. 10A and 10B. Therefore, the target detector recognizes the distance frequencies as those of the stationary target.

Subsequently, using a variety of conventional algorithms, the target detector performs pairing of the distance frequencies remaining after removing the distance frequencies of the stationary target, which are considered those due to the same target. Further, the target detector recognizes the paired distance frequencies as those of the moving target. Then, the target detector calculates the relative distance and relative velocity to the moving target based on the paired distance frequencies as described in FIG. 8. For example, the target detector recognizes the distance frequencies 121 and 122 as a pair as shown in FIGS. 10A and 10B and then, calculates the relative distance and relative velocity to the moving target based on the distance frequencies 121 and 122.

There is conventionally provided a target detector in which a future peak signal frequency is estimated from past detection information on a target and a peak signal higher than the threshold changed by a threshold change section is determined as the detection peak of the target in an estimation area which contains the estimated peak signal frequency (see, e.g., Japanese Unexamined Patent Publication No. 2002-311131).

Incidentally, assume that a level of the distance frequencies exists near the threshold in the listing of the distance frequencies. In this case, the level of the distance frequencies exceeds or does not exceed the threshold at random in each of the frequency rising section and the frequency falling section. For example, there is a case where a distance frequency in the frequency rising section is listed and a distance frequency to be paired in the frequency falling section is not listed. As a result, there arise the following problems. That is, since one of the distance frequencies to be paired is not listed, distance frequency components originally due to the stationary target may be erroneously recognized as distance frequency components due to the moving target.

Further, in the pairing of the distance frequencies of the moving target, the distance frequencies different in the frequency rising section and the frequency falling section must be combined using limited judgment information. Therefore, reliable judgment is difficult. Accordingly, even if only a slight number of distance frequencies due to the stationary target are mixed in a candidate for the distance frequencies subjected to the pairing operation, it becomes increasingly difficult to make a determination. As a result, detection accuracy of the moving target is worsened.

### SUMMARY OF THE INVENTION

In view of the foregoing, it is an object of the present invention to provide a target detector for accurately detecting the frequency components of the stationary target, detecting a moving target from the remaining frequency components and suppressing erroneous detection of the moving target.

It is another object of the present invention to provide a target detection method using the target detector.

To accomplish the above-described objects, according to the present invention, there is provided a target detector for calculating a relative distance and relative velocity to a target. This detector comprises: a transmitting and receiving section for transmitting a transmission wave and receiving a reflected wave from the target, the transmission wave having a frequency rising section where the frequency increases and a frequency falling section where the frequency decreases; a mixer for mixing the transmission wave and the reflected wave to generate beat signals; a frequency calculating section for calculating frequency components of the beat signals in the frequency rising section and the frequency falling section; and a stationary target frequency detecting section for, when a level of the frequency components in one of the frequency rising section and the frequency falling section exceeds a higher threshold and a level of the same frequency components in the other section exceeds a lower threshold as well as a level difference between both the frequency components is within a predetermined range, detecting these frequency components as those of the stationary target.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 shows an outline of a target detector.

FIG. 2 is an example of a block diagram of the target detector.

FIG. 3 is a functional block diagram of a digital signal processor.

FIG. 4 illustrates detection of distance frequencies of a stationary target.

FIG. 5 illustrates a probability of erroneous recognition among respective thresholds in FIG. 4.

FIG. 6 illustrates a probability of erroneous recognition among respective thresholds in FIG. 4.

FIG. 7 shows an example of a frequency change in a transmission wave output from the target detector.

FIGS. 8A, 8B and 8C show a frequency spectrum of a beat signal between a transmission wave and a reflected wave.

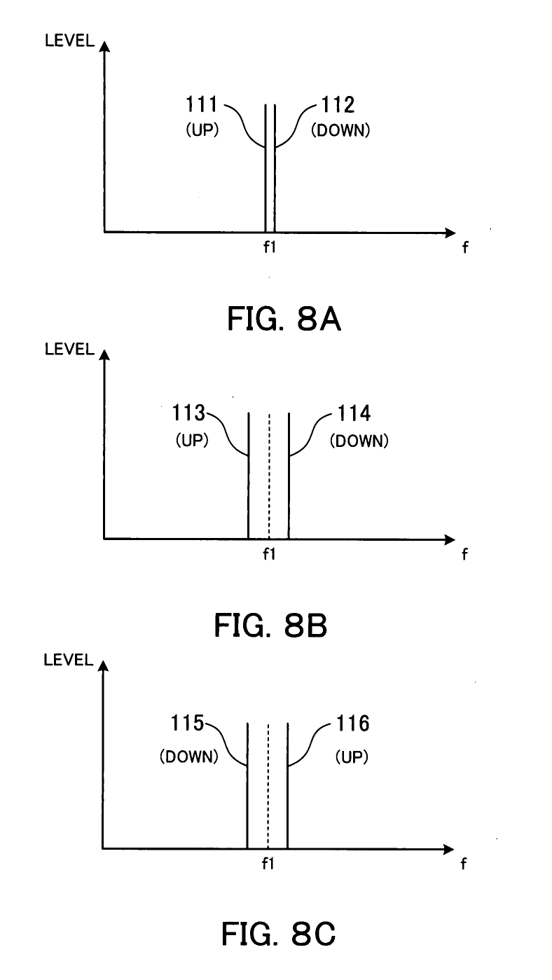

FIG. 9 illustrates listing of the distance frequency.

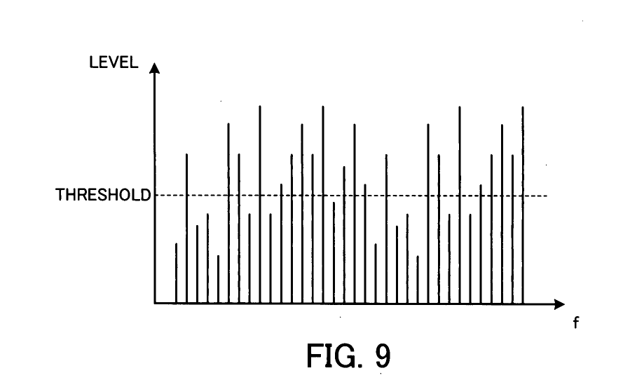

FIGS. 10A and 10B illustrate pairing.

### DESCRIPTION OF THE PREFERRED EMBODIMENTS

Principles of the present invention will be described in detail below with reference to the accompanying drawings.

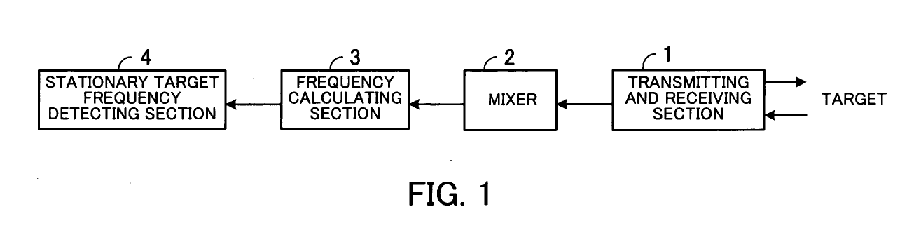

FIG. 1 shows an outline of a target detector. As shown in FIG. 1, the target detector has a transmitting and receiving section 1, a mixer 2, a frequency calculating section 3 and a stationary target frequency detecting section 4.

The transmitting and receiving section 1 transmits a transmission wave and receives a reflected wave from a target. The transmission wave has a frequency rising section where the frequency increases and a frequency falling section where the frequency decreases.

The mixer 2 mixes the transmission wave transmitted to the target and the reflected wave reflected from the target to generate a beat signal.

The frequency calculating section 3 calculates frequency components (spectrum) of the beat signal in the frequency rising section and the frequency falling section.

The stationary target frequency detecting section 4, when a level of the frequency components in one of the frequency rising section and the frequency falling section exceeds a higher threshold and a level of the same frequency components in the other section exceeds a lower threshold as well as a level difference between both the frequency components is within a predetermined range, detects these frequency components as those of the stationary target.

More specifically, the section 4, when a level of the frequency components in one of the frequency rising section and the frequency falling section exceeds a higher threshold and a level of the same frequency components in the other section exceeds a lower threshold, picks up these frequency components as a pair candidate for the frequency components of a stationary target. Further, the section 4, when a level difference between both the frequency components is within a predetermined range, detects these frequency components as those of the stationary target.

Thus, the target detector, when a level of the frequency components in one of the frequency rising section and the frequency falling section exceeds a higher threshold and a level of the same frequency components in the other section exceeds a lower threshold, detects these frequency components as those of the stationary target.

As a result, the frequency components of the stationary target can be detected with high accuracy as well as the frequency components of a moving target can be detected from the frequency components remaining after removing those of the stationary target detected with high accuracy. Therefore, an erroneous detection of the moving target can be suppressed.

Next, Preferred embodiment of the present invention will be described in detail with reference to the accompanying drawings, wherein like reference numerals refer to like elements throughout.

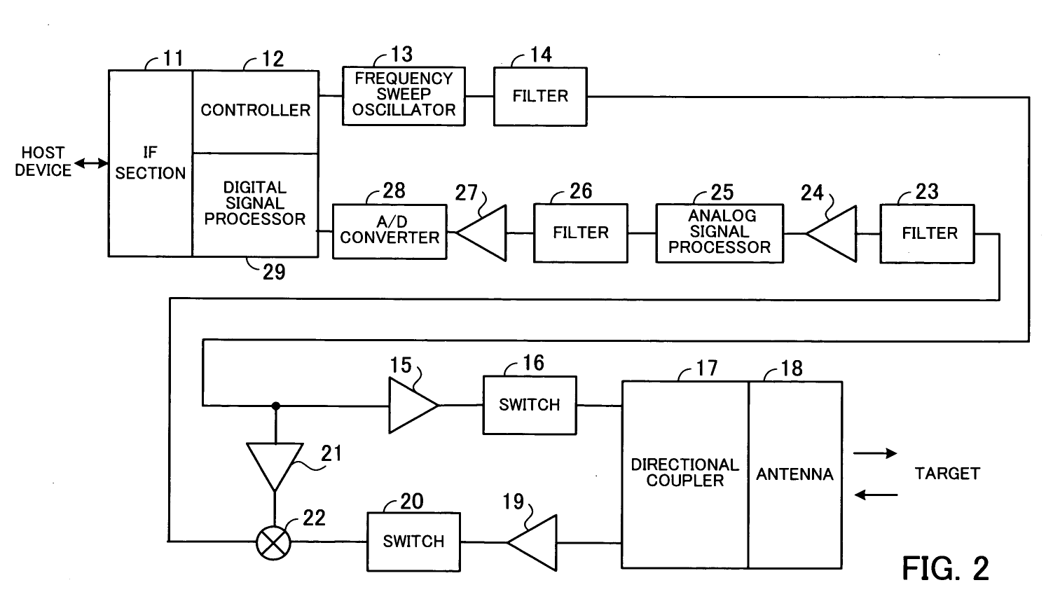

FIG. 2 is an example of a block diagram of the target detector. As shown in FIG. 2, the target detector has an IF section 11, a controller 12, a frequency sweep oscillator 13, filters 14, 23 and 26, amplifiers 15, 19, 21, 24 and 27, switches 16 and 20, a directional coupler 17, an antenna 18, a mixer 22, an analog signal processor 25, an A/D converter 28 and a digital signal processor 29.

The IF section 11 is connected to a host device such as a CPU (Central Processing Unit) which controls the whole target detector and performs communication with the host device. The IF section 11 informs the controller 12 and the digital signal processor 29 of instructions from the host device. Further, the IF section 11 informs the host device of control results from the controller 12 and the digital signal processor 29.

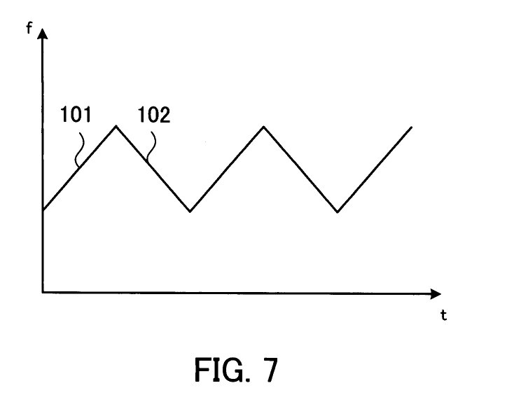

The controller 12 controls the frequency sweep oscillator 13. Under the control of the controller 12, the frequency sweep oscillator 13 outputs a transmission wave for wirelessly transmitting a radio wave such as a millimeter wave while sweeping the frequency. A frequency of the transmission wave is divided into the frequency rising section where the frequency increases and the frequency falling section where the frequency decreases. For example, a frequency of the transmission wave is divided into the frequency rising section and the frequency falling section as shown in FIG. 7.

In the transmission wave output from the frequency sweep oscillator 13, excessive frequencies are cut by the filter 14. In other words, the filter 14 cuts the frequency such that only the transmission wave having necessary frequency components is wirelessly transmitted from the antenna 18.

The amplifier 15 amplifies signals output from the filter 14 and outputs the amplified signals to the switch 16. The switch 16 performs on/off operations and outputs the transmission wave to the directional coupler 17 only when performing the on operation.

The directional coupler 17 outputs the transmission wave output from the switch 16 only to the antenna 18 but not to the amplifier 19. Further, the coupler 17 outputs the reception wave received by the antenna 18 only to the amplifier 19 but not to the switch 16.

The antenna 18 wirelessly transmits to a target the transmission wave output from the directional coupler 17, and receives the reception wave reflected and returned from the target.

The amplifier 19 amplifies the reception wave output from the directional coupler 17 and outputs the amplified wave to the switch 20. The switch 20 performs on/off operations and outputs the reception wave to the mixer 22 only when performing the on operation.

The amplifier 21 amplifies the transmission wave output from the filter 14 and outputs the amplified wave to the mixer 22. The mixer 22 mixes the reception wave output from the switch 20 and the transmission wave output from the amplifier 21 to generate a beat signal, and outputs the beat signal to the filter 23.

The filter 23 outputs only the beat signal in a predetermined frequency band to the amplifier 24 and removes noise components included in the beat signal. The amplifier 24 amplifies the beat signal output from the filter 23 and outputs the amplified beat signal to the analog signal processor 25.

The analog signal processor 25 includes, for example, a hold circuit and an integration circuit. Since the reception wave has a waveform cut up into pieces by switching of the switch 20, the hold circuit and integration circuit of the processor 25 causes the beat signal to have a continuous waveform.

The filter 26 removes, from the beat signal, excessive signals included in the output from the analog signal processor 25. The amplifier 27 amplifies the beat signal output from the filter 26 and outputs the amplified beat signal to the A/D converter 28. The A/D converter 28 subjects the amplified beat signal to analog-digital conversion and outputs the resultant signal to the digital signal processor 29.

The digital signal processor 29 calculates a frequency component (distance frequency) of the beat signal, for example, using FFT (Fast Fourier Transform). Further, the processor 29 detects peak frequencies of the same distance frequencies in the frequency rising section and the frequency falling section using plural thresholds to detect the distance frequencies of a stationery target. Then, the digital signal processor 29 performs pairing of the distance frequencies remaining after removing those of the stationery target using a predetermined algorithm to detect the distance frequencies of a moving target. Further, the processor 29 calculates a relative distance to the stationery target based on the detected distance frequencies of the stationery target as well as calculates a relative distance and relative velocity to the moving target based on the detected distance frequencies of the moving target.

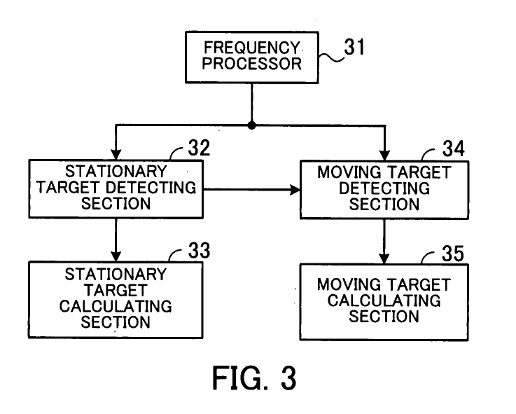

FIG. 3 is a functional block diagram of the digital signal processor. As shown in FIG. 3, the digital signal processor 29 has a frequency processor 31, a stationery target detecting section 32, a stationery target calculating section 33, a moving target detecting section 34 and a moving target calculating section 35. The digital signal processor 29 is realized, for example, using DSP (Digital Signal Processor) or a hardware.

The frequency processor 31 calculates frequency components of the beat signal, for example, using the FFT.

The stationary target detecting section 32 sets a plurality of different thresholds in the frequency rising section and frequency falling section and detects the same distance frequencies having a level exceeding the plurality of set thresholds. That is, the section 32 lists the distance frequencies of the stationary target using the plurality of different thresholds.

The stationary target detecting section 32, when a level of the frequency components in one of the frequency rising section and the frequency falling section exceeds a higher threshold and a level of the same frequency components in the other section exceeds a lower threshold as well as a level difference between both the frequency components is within a predetermined range, detects these frequency components as those of the stationary target.

For example, assume that the stationary target detecting section 32 sets two different thresholds. The stationary target detecting section 32, when the distance frequencies having a level exceeding a higher threshold exist in one of the frequency rising section and the frequency falling section and a level of the same distance frequencies in the other section exceeds a lower threshold as well as a level difference between both the frequency components is within a predetermined range, detects a pair of these distance frequencies as those of the stationary target.

Here, three or more thresholds may be set. For example, an intermediate threshold (a threshold between the higher threshold and the lower threshold) is set such that the number of the thresholds is equal to three. In this case, even if a level of the distance frequencies in one of the frequency rising section and the frequency falling section does not exceed the higher threshold, when levels of the distance frequencies in both the sections exceed the intermediate threshold, the stationary target detecting section 32 detects these distance frequencies as those of the stationary target. By adding a determination as to whether the levels exceed the intermediate threshold, a consistency between the expected value statistically guessed and the presence or absence of the detection can be improved (positive relativity can be improved).

The stationary target calculating section 33 calculates a relative distance to the stationary target based on the distance frequencies of the stationary target detected by the stationary target detecting section 32.

The moving target detecting section 34 detects, based on the predetermined algorithm, a pair of distance frequencies of the moving target from among a group of the distance frequencies remaining after removing those of the stationary target detected by the stationary target detecting section 32. The stationary target detecting section 32 sets a plurality of thresholds and accurately detects the distance frequencies of the stationary target. Therefore, there is suppressed erroneous mixing of the distance frequencies due to the stationary target, which becomes a hindering factor of the pairing accuracy, in a candidate for the distance frequencies of the moving target detected by the moving target detecting section 34. As a result, the erroneous detection of the moving target is reduced.

The moving target calculating section 35 calculates a relative distance and relative velocity to the moving target based on the distance frequencies of the moving target detected by the moving target detecting section 34.

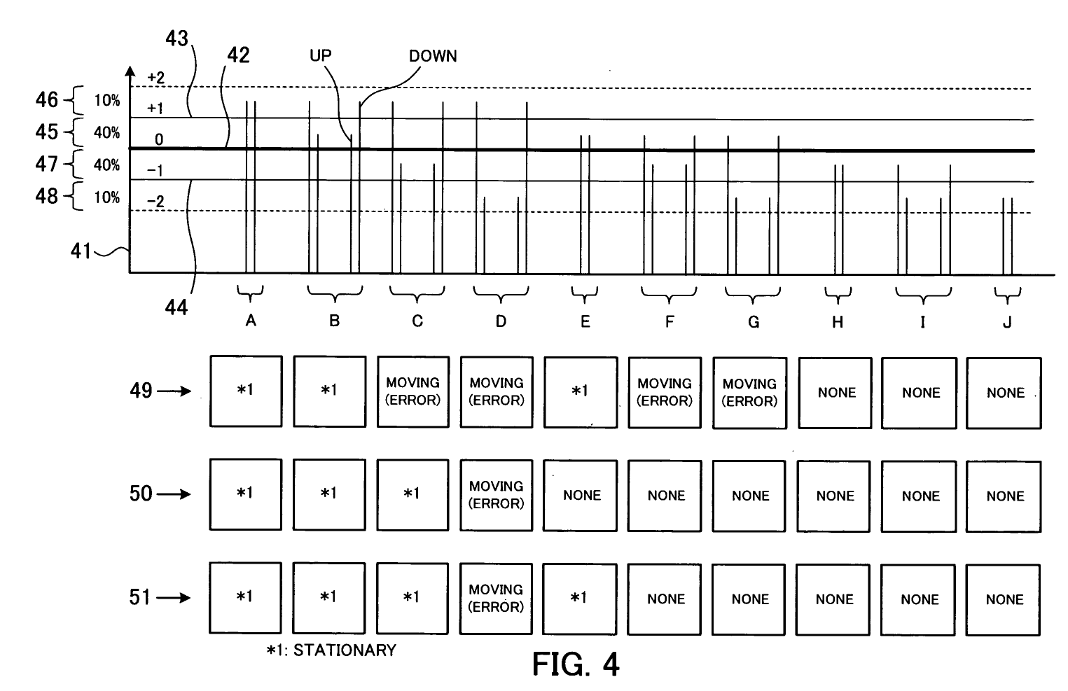

FIG. 4 illustrates detection of the distance frequencies of the stationary target. In FIG. 4, plural distance frequencies of from A to J are represented. The longitudinal axis 41 represents a level of the distance frequencies. In the respective distance frequencies of from A to J, the left side represents a level of the distance frequency in the frequency rising section (UP). The right side represents a level of the distance frequency in the frequency falling section (DOWN).

Further, thresholds 42 to 44 for detecting the distance frequencies of the stationary target are represented. Further, regions 45 to 48 between the thresholds are represented. Here, assume an example where there exists a stationary target whose “true average level” (an average level of the distance frequencies including a reflection characteristic change of the stationary target due to noise and differences in observation time) is equivalent to a level very slightly higher than (almost equivalent to) the level zero in FIG. 4. In this example, assume that a level of the distance frequency observed with an error is as follows. The probability for the level to appear at a level in the region 45 is 40%.

Similarly hereinafter, the probability for the level to appear at a level in the region 46 is 10%. The probability for the level to appear at a level in the region 47 is 40%. The probability for the level to appear at a level in the region 48 is 10%. In other words, assume that the level of the distance frequency observed is distributed around the intermediate threshold 42. Further, assume that as the level is more away from the threshold 42, the probability for the level of the distance frequency observed becomes smaller and the level of the distance frequency fails to be observed at a level above the region 46 or at the level below the region 48.

The above possibility is assumed on the assumption that since the “true average level” (a level which cannot be known from the observation) is assumed to be almost equivalent to the level zero, the levels of the distance frequencies observed at a relatively high or low level due to errors are almost equally distributed above and below the level zero. Further, since the “true average level” is assumed to be a level almost equivalent to or very slightly higher than the level zero, when the level zero is set to the same level as an original target threshold for the detection (although being not always so set), the level of the distance frequencies of the above stationary target is desired to be detected.

The distance frequencies in the frequency rising section and frequency falling section shown in A to J of FIG. 4 are separately represented; however, these distance frequencies are those of the same frequency and to be detected as the distance frequencies of the stationary target.

Description will be first made on the detection of the distance frequencies of the stationary target in the case where one threshold is set. The threshold is generally set at the center of regions 45 to 48 where levels of the distance frequencies exist. Accordingly, the threshold 42 is set as a threshold for detecting the distance frequencies of the stationary target. This is an example in which the level zero is set to the same level as an original target threshold for the detection.

In the case where the distance frequencies appear as in A, B and E of FIG. 4, the distance frequencies exceed the threshold 42. Therefore, the target detector can appropriately detect these distance frequencies as those of the stationary target.

On the other hand, in the case where the distance frequencies appear as in C, D, F and G, although one of the distance frequencies in the frequency rising section and the frequency falling section exceeds the threshold 42, the other distance frequency does not exceed the threshold 42. Therefore, the target detector does not detect these distance frequencies as those of the stationary target. It is of no importance that these distance frequencies are not detected as those of the stationary target because their expected values (described later) as a pair are zero. However, the target detector erroneously recognizes that the one distance frequency exceeding the threshold (in the frequency rising section or the frequency falling section) is a candidate for the distance frequency of the moving target. In other words, the target detector erroneously recognizes that since one of the distance frequencies exceeds the threshold 42, a distance frequency to be paired exists at a different frequency.

In the case where the distance frequencies appear as in H, I and J, both of the distance frequencies in the frequency rising section and the frequency falling section do not exceed the threshold 42. Therefore, the target detector does not detect these distance frequencies as those of the stationary target and the moving target. More specifically, although the distance frequencies as in H, I and J are originally the distance frequencies of the stationary target, the target detector does not recognize these distance frequencies. Accordingly, the target detector does not erroneously recognize these distance frequencies as those of the moving target as in the above C, D, F and G.

Thus, in the case where one threshold is set, the target detector erroneously recognizes the distance frequencies having a pattern represented in C, D, F and G as a candidate for the distance frequencies of the moving target. An arrow 49 of FIG. 4 indicates detected states of the respective distance frequencies of from A to J in the case of one threshold.

Description will be next made on the detection of the distance frequencies of the stationary target in the case where two thresholds are set. The thresholds 43 and 44 are set as the thresholds for detecting the distance frequencies of the stationary target.

In the case where the distance frequencies appear as in A in FIG. 4, the distance frequencies in both of the frequency rising section and the frequency falling section exceed the threshold 43. Accordingly, the target detector detects the distance frequencies of A as those of the stationary target.

In the case where the distance frequencies appear as in B and C, although only the distance frequency in one section exceeds the higher threshold 43, the distance frequency in the other section does not exceed the threshold 43. Even in this case, when one of the distance frequencies exceeds the higher threshold 43 and the other distance frequency to be paired exceeds the lower threshold 44 even if failing to exceed the threshold 43, the target detector detects these distance frequencies as those of the stationary target. It is preferable that these distance frequencies are detected as those of the stationary target because their expected values as a pair (described later) are positive. Further, the following great merit is obtained.

In the case of one threshold, the distance frequencies of C are erroneously recognized as a candidate for the distance frequencies of the moving target. In the case of two thresholds, even the distance frequencies of C can be appropriately detected as those of the stationary target and therefore, are prevented from erroneously mixing in a candidate for the distance frequencies of the moving target.

However, even in the case of two thresholds, when both of the distance frequencies do not exceed the higher threshold 43 as represented in E, the distance frequencies of E cannot be discriminated by the processing using two thresholds. Further, although it is understood from FIG. 4 that the expected value is higher than the intermediate threshold (this threshold is considered a target threshold), the target detector does not detect the distance frequencies of E as those of the stationary target. An arrow 50 of FIG. 4 indicates detected states of the respective distance frequencies of from A to J in the case of two thresholds.

Description will be next made on the detection of the distance frequencies of the stationary target in the case where three thresholds are set. The threshold 42 between the thresholds 43 and 44 is set as a third threshold for detecting the distance frequencies of the stationary target.

In the case where the distance frequencies appear as in A, B and C in FIG. 4, the target detector detects the distance frequencies of A, B and C as those of the stationary target in the same manner as in the case of two thresholds.

In the case where the distance frequencies appear as in E, the distance frequencies in both of the frequency rising section and the frequency falling section do not exceed the higher threshold 43. Even in this case, when the distance frequencies in both of the frequency rising section and the frequency falling section exceed the intermediate threshold 42, the target detector detects these distance frequencies as those of the stationary target. That is, the target detector performs the detection of the distance frequencies by adopting the intermediate threshold 42 to add the processing using one threshold to the processing using two thresholds.

Accordingly, in the case of two thresholds, the distance frequencies of E cannot be discriminated by the processing using two thresholds. Further, although it is understood from FIG. 4 that the expected value is higher than the intermediate threshold (this threshold is considered a target threshold), the target detector does not detect the distance frequencies of E as those of the stationary target. In the case of three thresholds, the target detector can appropriately detect even the distance frequencies of E as those of the stationary target. An arrow 51 of FIG. 4 indicates detected states of the respective distance frequencies of from A to J in the case of three thresholds.

Next, description will be made on the probability that among the respective thresholds in FIG. 4, the distance frequency components due to the stationary target are erroneously recognized as a pair candidate for the distance frequencies of the moving target.

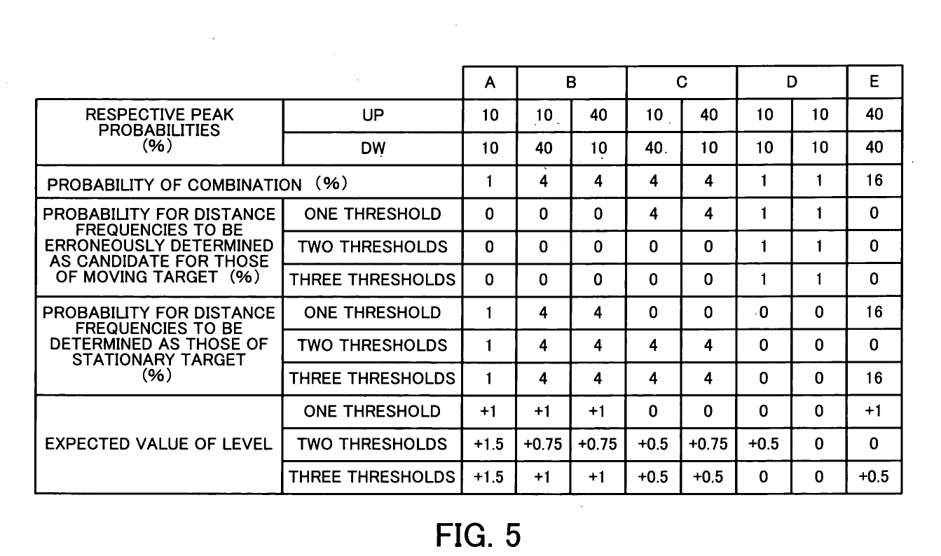

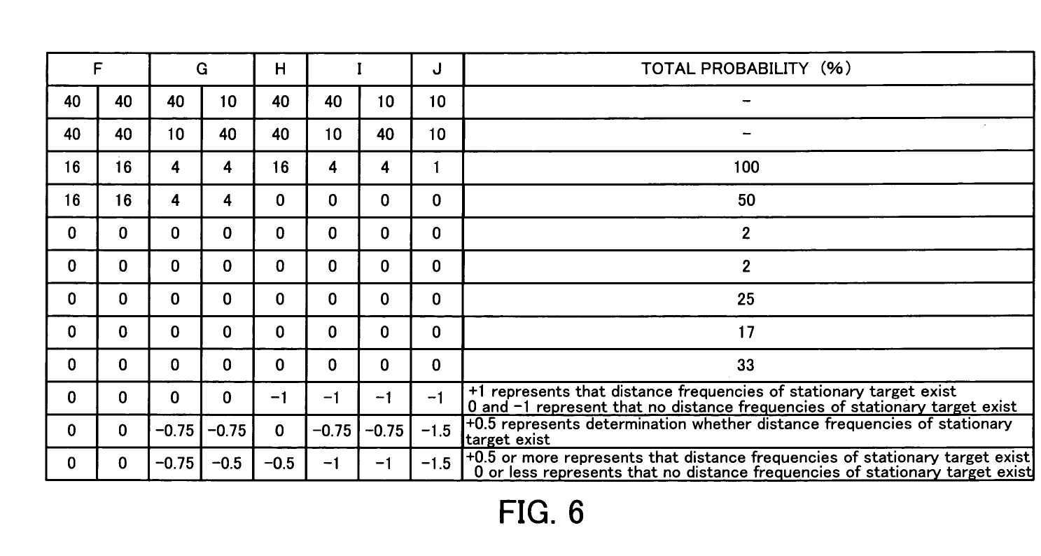

FIGS. 5 and 6 illustrate the probability of erroneous recognition among the respective thresholds in FIG. 4. A table shown in FIG. 6 leads up from the right edge of a table in FIG. 5.

A column of “respective peak probabilities” shown in FIGS. 5 and 6 represents the probability for the states of the distance frequencies represented in A to J of FIG. 4 to appear. Each of B, C, D, F, G and I in FIGS. 5 and 6 has two columns. The right and left columns in each state correspond to the right and left sides of the distance frequencies represented in A to J of FIG. 4, respectively. Further, columns of “UP and DOWN” in FIGS. 5 and 6 represent the probabilities in the frequency rising section and the frequency falling section, respectively.

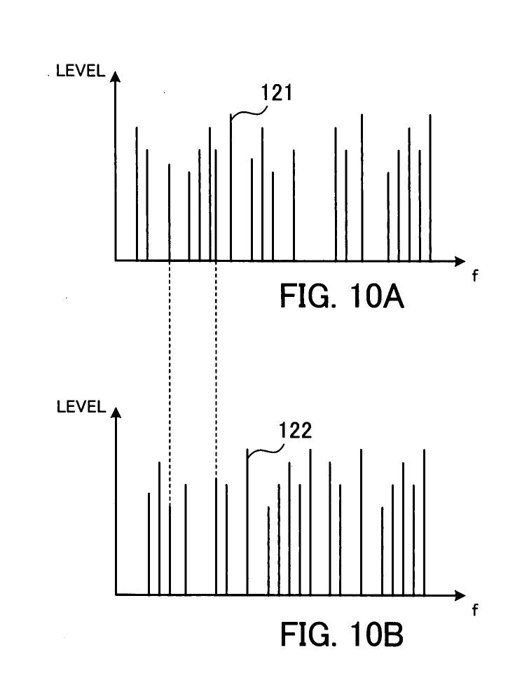

As described in FIG. 4, it is assumed that the probability for the distance frequencies to appear in the region 46 is 10%. Accordingly, for example, the probability for the distance frequencies of A in FIG. 4 to appear are 10% in both of the frequency rising section and the frequency falling section. Therefore, in the “respective peak probabilities” column of A in FIGS. 5 and 6, 10% is stored in each of the “UP and DW” columns.

Further, as described in FIG. 4, it is assumed that the probabilities for the distance frequencies to appear in the regions 45 and 46 are 40% and 10%, respectively. Accordingly, for example, the probabilities for the distance frequencies represented on the left side of B in FIG. 4 to appear are 10% in the frequency rising section and 40% in the frequency falling section, respectively. Therefore, in the “respective peak probabilities” column in FIGS. 5 and 6, 10% and 40% are stored in the “UP and DW” columns in the left column of B, respectively.

A column of “probability of a combination” shown in FIGS. 5 and 6 represents the probabilities for the distance frequencies of from A to J to appear in both of the frequency rising section and the frequency falling section. For example, the “probability of a combination” of A (the probability for the state of “A” to appear in both the sections) is equal to 1% resulting from multiplying the probability 10% in the UP column by the probability 10% in the DW column in the “respective peak probabilities”. The “probability of a combination” on the left side of B is equal to 4% resulting from multiplying the probability 10% in the UP column by the probability 40% in the DW column in the “respective peak probabilities”.

The states of the distance frequencies in FIG. 4 represent all the patterns that fall within the regions 45 to 48. Accordingly, the probability of a combination amounts to 100%.

The column of “probability for the distance frequencies to be erroneously determined as a candidate for those of the moving target” shown in FIGS. 5 and 6 represents the probability that the target detector erroneously recognizes the distance frequencies of the stationary target as a candidate for those of the moving target. This column represents the respective probabilities in the cases of one threshold, two thresholds and three thresholds.

The distance frequencies in the state of A shown in FIG. 4 are recognized as those of the stationary target without erroneous recognition in all the cases of one threshold, two thresholds and three thresholds. Accordingly, the probability for the distance frequencies in the state of A to be erroneously determined as a candidate for those of the moving target is 0% in all the cases of the threshold.

The distance frequencies in the state of C shown in FIG. 4 are erroneously recognized as a candidate for those of the moving target in the case of one threshold as illustrated in FIG. 4. Accordingly, in the “possibility for the distance frequencies to be erroneously determined as a candidate for those of the moving target” column of C in FIGS. 5 and 6, the probability for the state of C to appear is represented in the “one threshold” column. That is, in the “probability for the distance frequencies to be erroneously determined as a candidate for those of the moving target” column of C in FIGS. 5 and 6, 4% of the “probability of a combination” of C is stored in the “one threshold” column.

The distance frequencies in the state of D shown in FIG. 4 are erroneously recognized as a candidate for those of the moving target in all the cases of one threshold, two thresholds and three thresholds as illustrated in FIG. 4. Accordingly, in the “probability for the distance frequencies to be erroneously determined as a candidate for those of the moving target” column of D in FIGS. 5 and 6, the probability for the state of D to appear is represented in the “one threshold”, “two thresholds” and “three thresholds” columns. That is, in the “probability for the distance frequencies to be erroneously determined as a candidate for those of the moving target” column of D in FIGS. 5 and 6, 1% of the “probability of a combination” of D is stored in all the columns of one threshold, two thresholds and three thresholds.

In the respective cases of one threshold, two thresholds and three thresholds of A to J, the “probability for the distance frequencies to be erroneously determined as a candidate for those of the moving target” amounts to 50%, 2% and 2%, respectively, as represented in the column of the total probability. That is, when a plurality of the thresholds are set, the probability for the distance frequencies to be erroneously recognized as those of the moving target can be reduced.

The column of the “probability for the distance frequencies to be determined as those of the stationary target” shown in FIGS. 5 and 6 represents the probability that the target detector detects the distance frequencies as those of the stationary target. This column represents the respective probabilities in the cases of one threshold, two thresholds and three thresholds.

The distance frequencies in the state of A shown in FIG. 4 are recognized as those of the stationary target without erroneous recognition in all the cases of one threshold, two thresholds and three thresholds. Accordingly, the probability for the distance frequencies in the state of A to be determined as those of the stationary target is equal to the probability for the state of A to appear in all the cases of one threshold, two thresholds and three thresholds. That is, in the “probability for the distance frequencies to be determined as those of the stationary target” column of A in FIGS. 5 and 6, 1% of the “probability of a combination” of A is stored in all the columns of one threshold, two thresholds and three thresholds.

The distance frequencies in the state of C shown in FIG. 4 are erroneously recognized as a candidate for those of the moving target in the case of one threshold. Accordingly, in the “probability for the distance frequencies to be determined as those of the stationary target” column of C in FIGS. 5 and 6, 0% is stored in the “one threshold” column. In the cases of two thresholds and three thresholds, the distance frequencies in the state of C are determined as those of the stationary target. Accordingly, in the “probability for the distance frequencies to be determined as those of the stationary target” column of C, 4% of the “probability of a combination” of C is stored in the “two thresholds” and “three thresholds” columns.

The distance frequencies in the state of E shown in FIG. 4 are appropriately detected as those of the stationary target in the cases of one threshold and three thresholds. Accordingly, in the “probability for the distance frequencies to be determined as those of the stationary target” column of E in FIGS. 5 and 6, 16% is stored in the “one threshold” and “three thresholds” columns. In the case of two thresholds, the state of “E” is determined as no stationary target and no moving target. Accordingly, in the “probability for the distance frequencies to be determined as those of the stationary target” column of E in FIGS. 5 and 6, 0% is stored in the “two thresholds” column.

The column of “expected value of a level” shown in FIGS. 5 and 6 stores the expected value of the true average level in the case where a level of the distance frequencies is observed within the range of the regions 45 to 48 shown in FIG. 4. For example, the level of the distance frequencies is set to −2, −1, 0, +1 and +2 as shown in FIG. 4. In this case, the expected value in one threshold on the left side of B is as follows. Since the levels of the distance frequencies exist between 0 and +2 in both the frequency rising section and the frequency falling section, each of the expected values in both the sections is +1. Accordingly, when averaging these values, the expected value in one threshold on the left side of B becomes +1. The expected value in two thresholds on the left side of B is as follows. In the frequency rising section, since the level of the distance frequencies exists between +1 and +2, the expected value is +1.5. In the frequency falling section, since the level of the distance frequencies exists between −1 and +1, the expected value is 0. Accordingly, when averaging these values, the expected value in two thresholds on the left side of B becomes +0.75. The expected value in three thresholds on the left side of B is as follows. In the frequency rising section, since the level of the distance frequencies exists between +1 and +2, the expected value is +1.5. In the frequency falling section, since the level of the distance frequencies exists between 0 and +1, the expected value is 0.5. Accordingly, when averaging these values, the expected value in three thresholds on the left side of B becomes +1.0.

These expected values are values set based on the level zero (although being not always so set). In the case where the level zero is set to the same level as the original target threshold, if this expected value is positive, it is desired that the distance frequencies of the stationary target is detected. Meanwhile, if this expected value is negative, it is desired that the distance frequencies of the stationary target are prevented from being detected.

The method of using a plurality of thresholds has two merits. A description has been made with the focus placed on the item 2. Here, a supplementary description will be made in connection with the item 1 in terms of probability.

1. The detection accuracy of the distance frequencies of the stationary target is improved.

2. The probability for a signal due to the stationary target to mix in a candidate group for a signal of the moving target is reduced.

From the description in the “expected value of a level” column shown in FIGS. 5 and 6, it can be predicted that in the case of two thresholds or three thresholds, the digit number of the significant figures is increased and the accuracy of the expected value is improved as compared with the case of one threshold. Further, it can be read that a consistency between the expected value and the determination on the presence or absence of the detection of the distance frequencies of the stationary target is as follows. In the case of one threshold, when the expected value is +1, it is determined that the distance frequencies of the stationary target exist. Further, when the expected values are 0 and −1, it is determined that no distance frequencies of the stationary target exist. In the case of two thresholds, when the expected value is +0.5, it is determined whether the distance frequencies of the stationary target exist. In the case of three thresholds, when the expected value is +0.5 or more, it is determined that the distance frequencies of the stationary target exist. Further, when the expected value is 0 or less, it is determined that no distance frequencies of the stationary target exist.

In the case of three thresholds, a consistency between the positive and negative of the expected value and the presence or absence of the detection is improved as compared with the case of two thresholds. Specifically, there is no case where the same expected value produces different results.

In the respective cases of one threshold, two thresholds and three thresholds of A to J, the “probability for the distance frequencies to be determined as those of the stationary target” amounts to 25%, 17% and 33%, respectively. There is a difference between these values and 50% which is considered as an ideal value. The reason is that the expected value of zero uniformly results in no detection of the distance frequencies of the stationary target. The difference can be easily corrected by a uniform shift of each total of one threshold, two thresholds and three thresholds (equivalent of 0.25).

In comparison between the processing using one threshold and the processing using two thresholds, the following fact can be found. As far as the detection accuracy of the distance frequencies of the stationary target, the detection using the former processing may be appropriately performed as in the case of E. Therefore, both processings have advantages and disadvantages. In view of prevention of the erroneous mixing in a candidate for the distance frequencies of the moving target, the latter processing is surely advantageous.

In the pairing of the distance frequencies of the moving target, the distance frequencies different in the frequency rising section and the frequency falling section must be combined using limited information. Therefore, reliable determination is difficult. Accordingly, even if only a slight number of distance frequencies due to the stationary target come to be mixed in a candidate for the distance frequencies of the moving target, determination becomes increasingly difficult and mispairing increases. As a result, the detection and discrimination accuracy of the distance frequencies of the moving target are extremely worsened. One erroneous mixing of the distance frequency leads to one erroneous production of a pair of the distance frequencies of the moving target as well as leads to confusion in the pairing processing on plural candidates for the distance frequencies of the moving target. Further, an erroneous pair of the distance frequencies may be continuously produced. As the number of the erroneously mixed distance frequencies more increases, the probability of erroneous processing also more increases rapidly.

On the other hand, the target detector in FIG. 2 detects the distance frequencies of the stationary target using plural thresholds. Therefore, there is suppressed erroneous mixing of the distance frequencies due to the stationary target, which becomes a hindering factor of the pairing accuracy, in a candidate for the distance frequencies of the moving target. As a result, the erroneous detection of the distance frequencies of the moving target is reduced.

Further, it is essentially inevitable that the distance frequencies near the threshold exceed or do not exceed the threshold.

This problem can be improved by optimization of specifications, low noise design, and analog and digital filters. With respect to the stationary target, the detection accuracy can be further greatly improved by the average processing using a technique for performing sweeping operations plural times. With respect to the moving target, there is provided a method of predicting the moving destination from the past movement. However, this method has the following cases. That is, a speedy processing of the distance frequencies of the moving target newly coming in sight becomes important. Further, sufficient hardware resources (high-speed device or large-capacity memory) are inapplicable depending on specifications. Accordingly, application of this method may be difficult.

On the other hand, the target detector in FIG. 2 is a device capable of realizing the detection even by the processing completed only in the minimum unit derived from the distance frequencies. Therefore, it can be expected to attain upgrade without requiring the cost up due to increase in input of large resources.

The target detector of the present invention is designed to, when a level of the frequency components in one of the frequency rising section and the frequency falling section exceeds a higher threshold and a level of the same frequency components in the other section exceeds a lower threshold as well as a level difference between both the frequency components is within a predetermined range, detect these frequency components as those of the stationary target. As a result, the frequency components of the stationary target can be detected with high accuracy as well as the frequency components of the moving target can be detected from the frequency components remaining after removing those of the stationary target detected with high accuracy. Therefore, an erroneous detection of the moving target can be suppressed.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A target detector for calculating a relative distance and relative velocity to a target, comprising:
transmitting and receiving means for transmitting a transmission wave and receiving a reflected wave from the target, the transmission wave having a frequency rising section where the frequency increases and a frequency falling section where the frequency decreases;
a mixer for mixing the transmission wave and the reflected wave to generate beat signals;
frequency calculating means for calculating frequency components of the beat signals in the frequency rising section and the frequency falling section; and
stationary target frequency detecting means for, when a level of the frequency components in one of the frequency rising section and the frequency falling section exceeds a higher threshold and a level of the same frequency components in the other section exceeds a lower threshold as well as a level difference between both the frequency components is within a predetermined range, detecting these frequency components as those of the stationary target.

2. The target detector according to claim 1, wherein:
even if a level of the frequency components in one of the frequency rising section and the frequency falling section does not exceed the higher threshold, when levels of the frequency components in both the sections exceed an intermediate threshold between the higher threshold and the lower threshold as well as a level difference between both the frequency components is within a predetermined range, the stationary target frequency detecting means detects these frequency components as those of the stationary target.

3. The target detector according to claim 2, wherein:
the intermediate threshold is a threshold between the higher threshold and the lower threshold.

4. The target detector according to claim 1, further comprising:
moving target frequency detecting means for detecting the frequency components of the moving target from frequency components remaining after removing those of the stationary target.

5. A method of detecting a target using a target detector for calculating a relative distance and relative velocity to a target, the target detector having transmitting and receiving means, a mixer, frequency calculating means and stationary target frequency detecting means, the method comprising the steps of:
causing the transmitting and receiving means to transmit transmission wave and receive reflected wave from the target, the transmission wave having a frequency rising section where the frequency increases and a frequency falling section where the frequency decreases;
causing the mixer to mix the transmission wave and the reflected wave to generate a beat signal;
causing the frequency calculating means to calculate frequency components of the beat signals in the frequency rising section and the frequency falling section; and
causing the stationary target frequency detecting means to detect, when a level of the frequency components in one of the frequency rising section and the frequency falling section exceeds a higher threshold and a level of the same frequency components in the other section exceeds a lower threshold as well as a level difference between both the frequency components is within a predetermined range, these frequency components as those of the stationary target.
